(19) United States
(12) Patent Application Publication
(10) Pub. No.: US 2002/0057525 A1
(43) Pub. Date: May 16, 2002

(54) Method of manufacturing a magnetic element

(76) Inventor: Joannes Baptist Adrianus Dionisius Van Zon, Eindhoven (NL)

Correspondence Address: U.S. Philips Corporation, 580 White Plains Road, Tarrytown, NY, 10591, US

(21) Appl. No.: 09/850,595

(22) Filed: May 8, 2001

(30) Foreign Application Priority Data
May 11, 2000 (EP) 00201681.4

(51) Int. Cl. G11B 5/147

(52) U.S. Cl. 360/126

(57) ABSTRACT

In order to increase the information density on storage media the track width of a written magnetic pattern is made increasingly smaller. This requires write heads having appropriate flux guides. The method disclosed in this patent document provides such flux guides. The method includes the following steps:

depositing a non-magnetic layer (3) of sufficient thickness;

anisotropically etching the non-magnetic layer to form a steep wall of suitable dimensions at the required position of a flux guide;

depositing a magnetic material to form a magnetic layer (9) on the wall in such a manner that the magnetic layer has a thickness corresponding to the required track width;

removing undesired deposits of magnetic material but maintaining the magnetic layer on the wall;

depositing an insulating material (19a) to cover the magnetic layer.

The invention relates to a method of manufacturing a magnetic element having a length and a width and a height direction.

There is a constant need to store information at increasingly higher densities in magnetic storage media such as discs, particularly hard discs, and tapes, particularly magnetic tapes. In such media information is written in a pattern of magnetic tracks. Higher densities can be attained inter alia by reducing the track width of the magnetic tracks. Currently, tracks widths smaller than 1 μm and even smaller than 100 nm are already envisaged. Since the information to be stored on magnetic storage media must be written into the storage media with the aid of a magnetic write head, the write head itself then being disposed with its head face opposite the storage medium and the medium being moved with respect to the write head, the write head should comply with stringent requirements. A write head has a magnetic circuit which includes an inductive transducing element and a flux-guiding magnetic element made of a soft-magnetic material and terminating in the head face. Apart from the physical and chemical parameters the dimensions of the magnetic element should also comply with special requirements. Thus, the dimension of the magnetic element measured transversely to the direction of movement of the storage medium, i.e. the width of the magnetic element, should be adapted to the track width of the tracks of the storage medium. Typical is a width of 1 μm and smaller. Furthermore, a high write flux is necessary for the high-density recording of information into the storage medium, which requires a comparatively large dimension of the magnetic element viewed in a direction parallel to the direction of movement of the storage medium, i.e. the length of the magnetic element. Typical is a length of a few microns, for example 3-5 μm; the magnetic element should consequently have a comparatively large length/width ratio.

A method of manufacturing such a magnetic element is known from IEEE Transactions on Magnetics, Vol. 34, No. 4, Jul. 1998, pages 1481-1473; A New Write Head Trimmed at Wafer Level by Focussed Ion Beam; T. Koshikawa et al. In the known method an upper pole of a write head, fabricated with the aid of thin-film technology, is narrowed by means of a focussed ion beam (FIB). Both sides of the upper pole are then etched until this pole has a desired width. During etching of the upper pole recesses are formed in a comparatively wide lower pole in its surface facing the upper pole, which recesses are covered with a layer of Al₂O₃ after completion of the etching process. A disadvantage is that the upper pole cannot be given a desired width only after the poles have been manufactured. This means that additional manufacturing steps are required during production, while moreover the narrowing of the upper pole proceeds slowly because material must be removed over a comparatively great length. Furthermore, it is difficult to apply FIB at wafer level because head after head processing is necessary. A further disadvantage could be that if a read head is disposed underneath the write head the former is damaged during the ion bombardment.

It is an object of the invention to provide a method of manufacturing a magnetic element, which method does not have the aforementioned disadvantages.

This object is achieved with the method in accordance with the invention, which method is intended for the manufacture of a magnetic element having a length and a width and a height direction and is characterized by the following steps, which should be carrier out after one another and in the specified sequence:

forming, by removal of material, a recess in a non-magnetic layer having a thickness at least equal to the length of the magnetic element to be manufactured, which recess has an upright wall portion which extends in the height direction of the magnetic element to be manufactured;

depositing a magnetic material, so as to form a magnetic layer on the upright wall portion, which magnetic layer has a thickness related to the width of the magnetic element to be manufactured;

removing deposited magnetic material which is present at least near said magnetic layer on the upright wall portion and which is situated outside said layer;

covering the magnetic layer by depositing an insulating material.

After the magnetic layer has been covered with an insulating material the magnetic layer forms the desired magnetic element. The magnetic element obtained with the aid of the method in accordance with the invention is particularly suitable as a flux guide in a magnetic head. The method can be carried out by means of techniques which are known per se and which are used in the fabrication of thin-film heads. The method can be carried out completely at wafer level, i.e. a large number of, for example, 10,000 magnetic element precursors can be subjected to the same process steps at the same time. In the method in accordance with the invention the magnetic layer formed by deposition need not be thicker than the desired width of the magnetic element. An advantage of the method in accordance with the invention is that the width of the manufactured magnetic element is primarily determined by the thickness of the magnetic layer, which layer thickness can be maintained simply within narrow tolerance limits during deposition of the magnetic material. As a result of this, the method is particularly suitable for magnetic elements having a large length/width ratio.

It is to be noted that the non-magnetic layer can be a substrate or a top layer of, for example, a multi-layer structure, particularly a thin-film structure, formed by deposition, which deposition of such a layer may be part of the method in accordance with the invention. As a non-magnetic material an insulating material, for example SiO₂ or Al₂O₃ may be used. SiO₂ or Al₂O₃ are frequently used in thin-film techniques; SiO₂ being generally used in the fabrication of semiconductor products and Al₂O₃ being generally used in the manufacture of magnetic heads. Spinnable materials, such as suitable types of glass and resists, can also be used as non-magnetic materials. The non-magnetic layer may be of a temporary nature (sacrificial layer), the non-magnetic layer being removable selectively with respect to the magnetic layer.

As a magnetic material soft-magnetic materials may be used. Suitable materials, which are known per se, are NiFe alloys, CoFe alloys and CoNiFe alloys. Of the first-mentioned alloys particularly Ni₈₀Fe₂₀ and Ni₄₅Fe₅₅ are very suitable, of which particularly the last-mentioned alloy has a high saturation magnetization. Good results can be achieved particularly with electrodeposited materials having a suitable step coverage.

A variant of the method in accordance with the invention is characterized in that primarily anisotropic etching is employed to form the recess in the non-magnetic layer. In this way, material is removed from the non-magnetic layer in a well-defined manner, which results in a well-defined upright wall portion. The use of anisotropic etching of SiO₂ layers is known per se, etching speeds of over 1 μm/minute being attainable as a result of the high volatility of the etched-away material particles. Such etching speeds are high as compared with the etching speeds attainable in the case of anisotropic etching of magnetic materials. Furthermore, the result obtained as regards accuracy is better in the case of SiO₂ layers than in the case of magnetic layers. Anisotropic etching of Al₂O₃ layers also proceeds more rapidly and yields better results than anisotropic etching of magnetic layers. Attractive alternatives to the variant described above are defined in claims 3 and 4.

A variant of the method in accordance with the invention the invention is characterized in that the magnetic layer is formed by sputter-deposition and/or electroplating. Both techniques are known per se and are suitable for the formation of magnetic films in a well-controlled manner. The desired thickness of the magnetic layer to be formed can be obtained very accurately by one of the two techniques or a combination of the two techniques, even with an accuracy of up to some tenths of a nanometer. This means that this variant enables the width of the magnetic element to be realized with the same accuracy.

A variant of the method in accordance with the invention is characterized in that primarily anisotropic etching is employed for the removal of deposited material situated at least near the magnetic layer but outside this layer. This etching can be effected with a bombardment of ions from a wide-beam ion source by means of sputter-etching or ion-milling, or by means of a suitable anisotropic etching process (RIE process). In all cases an ion flux is aimed parallel or substantially parallel to the upright wall portion and, consequently, to the magnetic layer formed thereon, at those surfaces from which magnetic material is to be removed. As a result of this, the magnetic layer itself can remain unaffected or substantially unaffected. After complete removal of the magnetic material to be removed this process step, which can be carried out at wafer level, is stopped. Carrying out a process step at wafer level leads to a small spread in parameters, while in this case the process step itself can be carried out rapidly.

The invention also relates to a method of manufacturing a magnetic head suitable for writing information in very narrow magnetic tracks, particularly tracks narrower than 1 μm. If desired, the magnetic head may be provided with read means.

The method in accordance with the invention for manufacturing a magnetic head aims at evading the disadvantages of the method known from said IEEE publication.

This is achieved with the method in accordance with the invention intended for manufacturing a magnetic head having a head face and including a transducing element and a magnetic element coupled magnetically to the latter and terminating at the head face, the magnetic element being manufactured in accordance with the method in accordance with the invention for manufacturing a magnetic element.

The method in accordance with the invention for manufacturing a magnetic head is preferably characterized in that in which after the formation of the magnetic layer but before the removal of magnetic material additional material is deposited in an area which extends at a distance from the head face of the magnetic head to be manufactured, in order to make the magnetic layer thicker in said area. By means of this variant a magnetic head having a magnetic element is obtained, which has a desired small width at and near the head face of the magnetic head but which has a large width in an area of the magnetic head where the transducing element extends. Such a magnetic element precludes saturation of magnetic flux in the vicinity of the transducing element.

A variant of the method in accordance with the invention for manufacturing a magnetic head is characterized in that planarization is effected after covering of the magnetic layer by deposition of a non-magnetic layer. A planarization step is particularly desirable if topography-sensitive layers have to be provided in the subsequent part of the manufacturing process.

A variant of the method in accordance with the invention for manufacturing a magnetic head has the method steps as defined in claim 11. An alternative to this variant has the steps as defined in claim 12.

The invention further relates to a magnetic element manufactured by the method in accordance with the invention for manufacturing a magnetic element. The invention further relates to a magnetic head manufactured by the method in accordance with for manufacturing a magnetic head. Such a magnetic head has a head face and includes one or more transducing elements and the magnetic element in accordance with the invention, which functions as a flux guide and which is also referred as “magnetic pole element” elsewhere in the present document. A transducing element can be an inductive or a magnetoresistive transducing element.

With regard to the claims it is to be noted that various characteristic features as defined in the claims may occur in combination.

Hereinafter, the invention will be described in more detail, by way of example, with reference to the drawings, in which

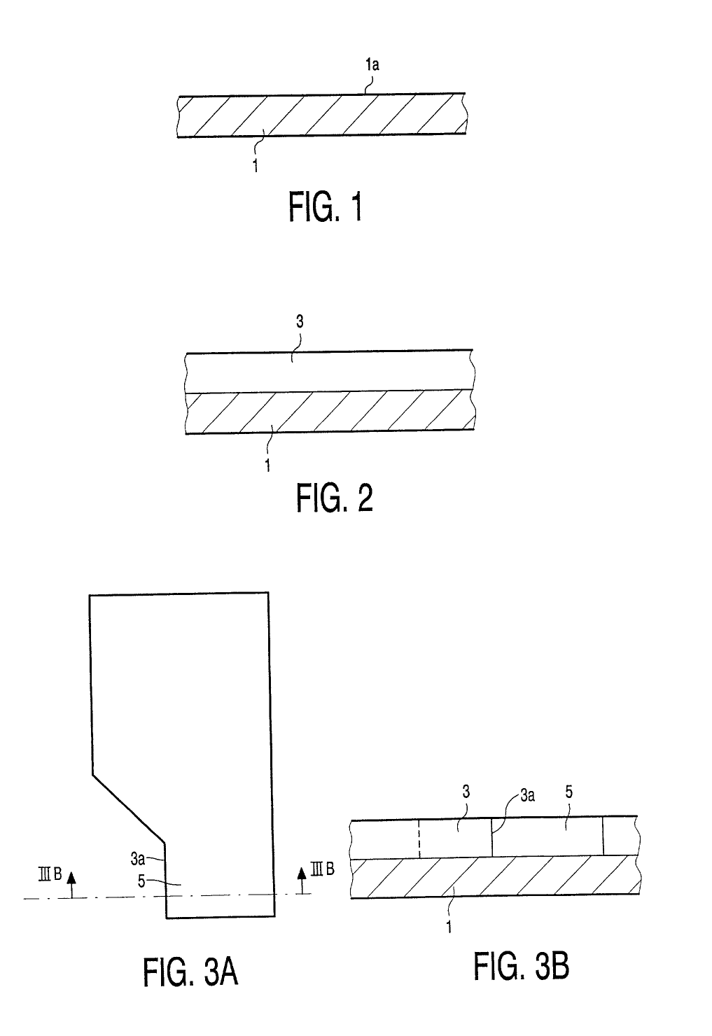

FIGS. 1 through 12A and 12B are diagrammatic plan views and cross-sectional views which illustrate various steps of a variant of the method in accordance with the invention for manufacturing a magnetic head, resulting in the magnetic head in a first embodiment of the invention shown diagrammatically in FIGS. 12A and 12B, and FIG. 13 shows the magnetic head in a second embodiment of the invention in a diagrammatic view.

A variant of the method in accordance with the invention for manufacturing a magnetic head will be described with reference to FIGS. 1 through 12A and 12B. This variant starts from a substrate 1 of a non-magnetic material, such as the ceramic material Al₂O₃TiC. The substrate 1, shown in sectional view in FIG. 1, has or is provided with a substrate surface 1a, which is obtained, for example, by polishing, on which surface 1a a non-magnetic layer 3 of, for example, Al₂O₃ or SiO₂ is formed by deposition, for example sputter deposition, as is shown in sectional view in FIG. 2. In the non-magnetic layer 3 a recess 5 is formed, as is shown in the plan view of FIG. 3A and in the sectional view IIIB-IIIB in FIG. 3B. The sectional view IIIB-IIIB, as is indicated in FIG. 3A, is taken at the location of a head face 7 to be formed, as shown in FIG. 12A. The recess 5, which is comparatively large in the present example, is obtained by anisotropic etching, which results in a steep or upright wall portion 3a, which bounds the recess 5. In this example etching proceeds until the substrate 1 is reached. As an alternative, it is possible to stop etching prior to this, as a result of which the recess has a bottom formed by a residual layer of the non-magnetic layer 3. As an alternative to said non-magnetic layer 3 a layer formed by spin-coating of a photoresist can be used, which layer, after drying, is exposed using a photomask. The recess 5 with the upright wall portion 3a is then formed during development. In accordance with a further alternative the non-magnetic layer 3 is obtained by deposition of a material, in the present example Hydrogen Silses Quioxane, which has such a sensitivity to a bombardment with electrons that after bombardment with a suitable electron beam the recess 5 with the wall portion 3a can be obtained.

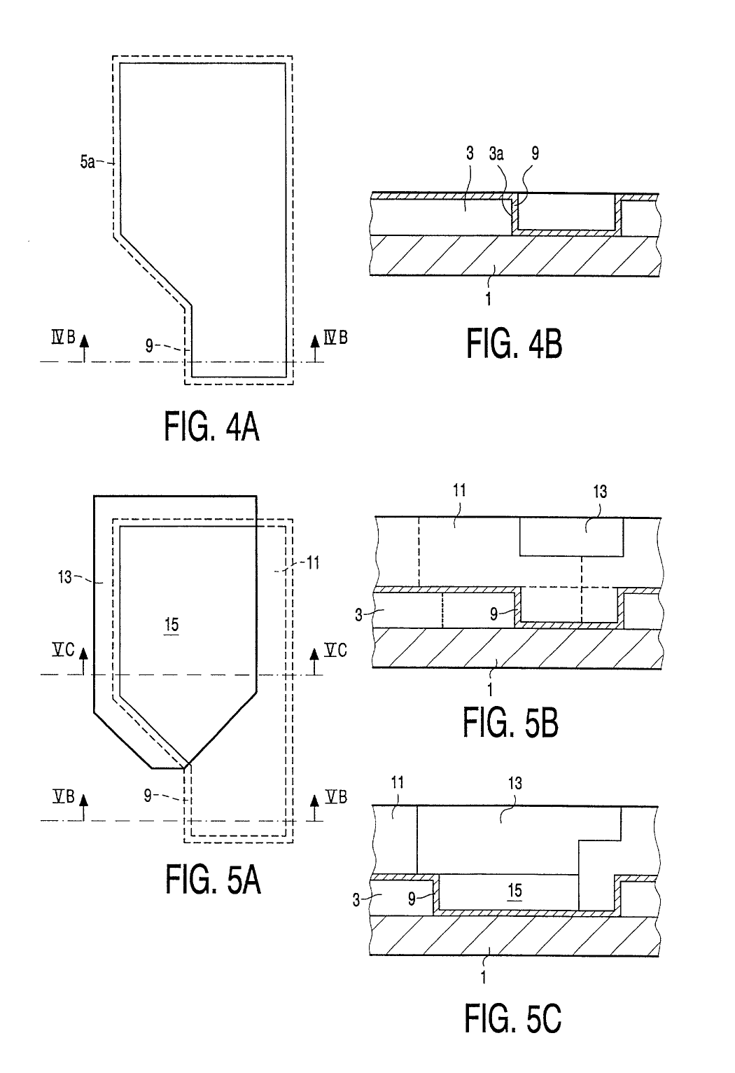

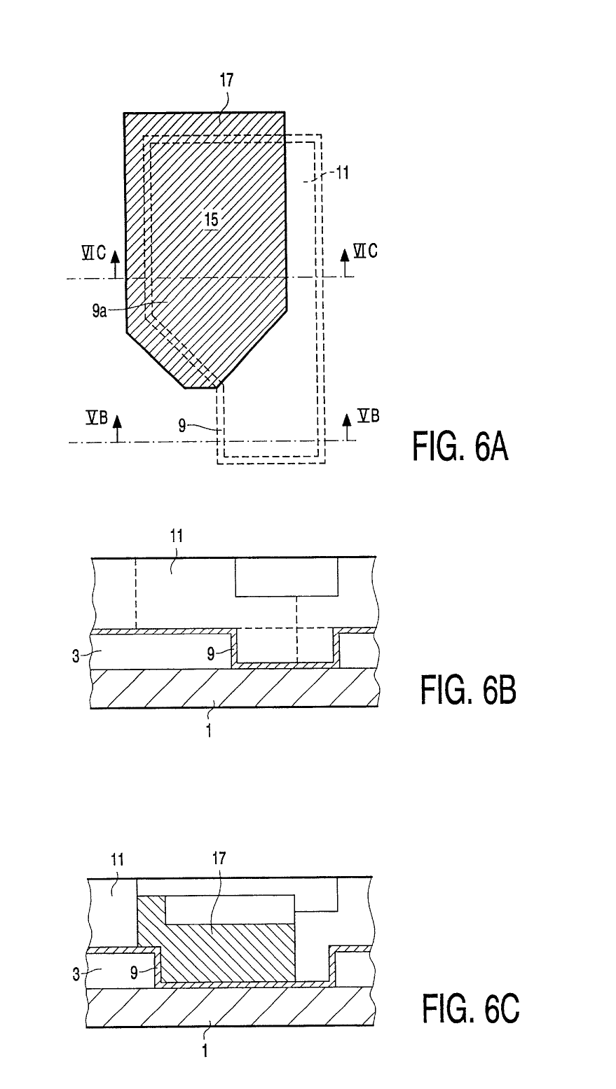

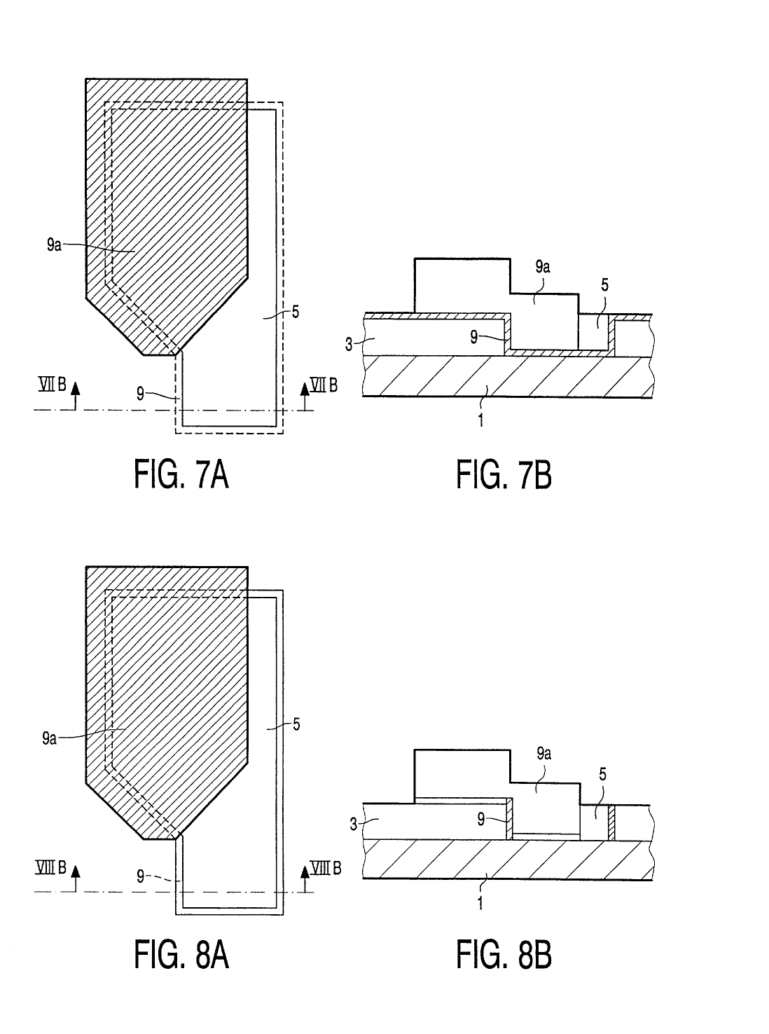

In the recess 5 thus formed a magnetic layer 9 is formed on the wall portion 3a, as is shown in the plan view of FIG. 4A and in the sectional view IVB-IVB in FIG. 4B. The magnetic layer 9 can be formed from a magnetic material, such as an NiFe alloy, by sputter-deposition or by an electroplating process or by a combination of the two technologies. After the deposition of the magnetic layer 9 there is also magnetic material on the bottom of the recess 5, on other walls of the recess 5 and in areas adjacent the recess 5. Subsequently, a photoresist is applied in the present example, in order to form a resist layer 11. This layer is dried and subsequently exposed using a suitable photomask. After this, the exposed photoresist is developed and removed by rinsing, which results in a recess 13 which renders an area 15 of the magnetic layer 9 accessible, which area is situated at a distance from the head face 7 to be formed (FIG. 12A). This situation is shown in the plan view of FIG. 5A and in the sectional views of FIGS. 5B and 5C. In the present example a magnetic material 17, in this example an NiFe alloy, is electrodeposited in said recess 13 in order to make the magnetic layer 9 thicker in the area 15, as is shown in the plan view of FIG. 6A and the sectional views of FIGS. 6B and 6C. The thickened portion of the magnetic layer 9 is referenced 9a. After deposition of the magnetic material 17 the residual portions of the resist layer 11 are removed, as is shown in the plan view of FIG. 7A and the sectional view of FIG. 7B.

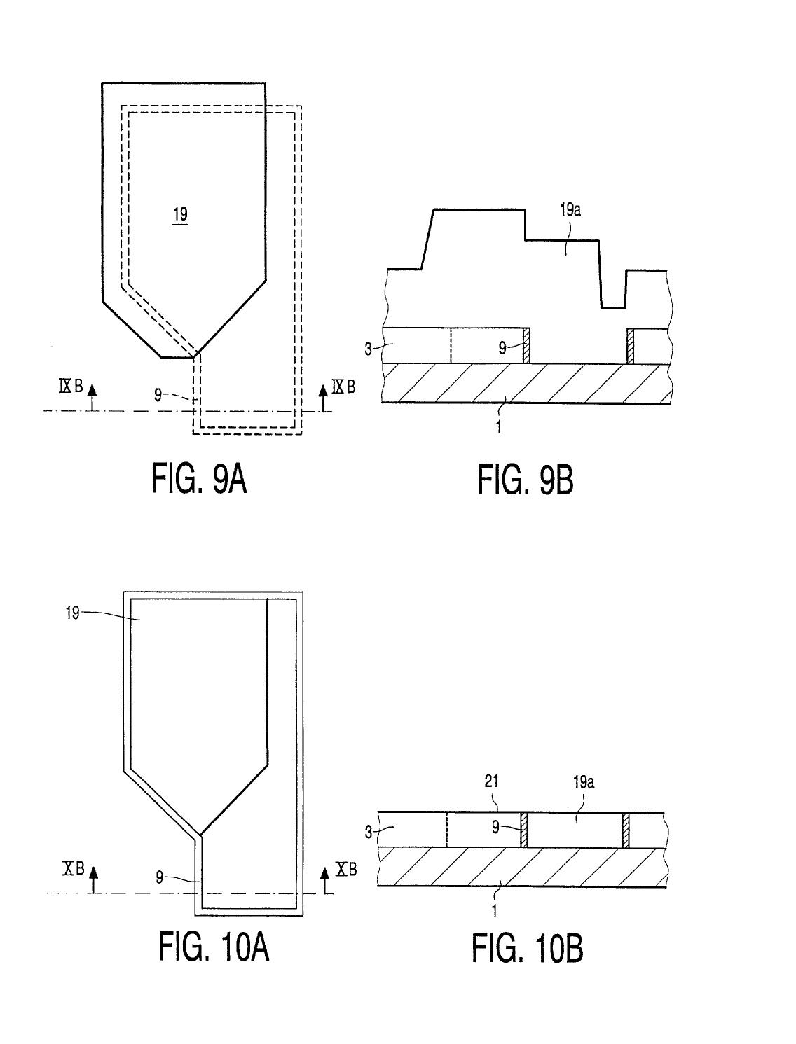

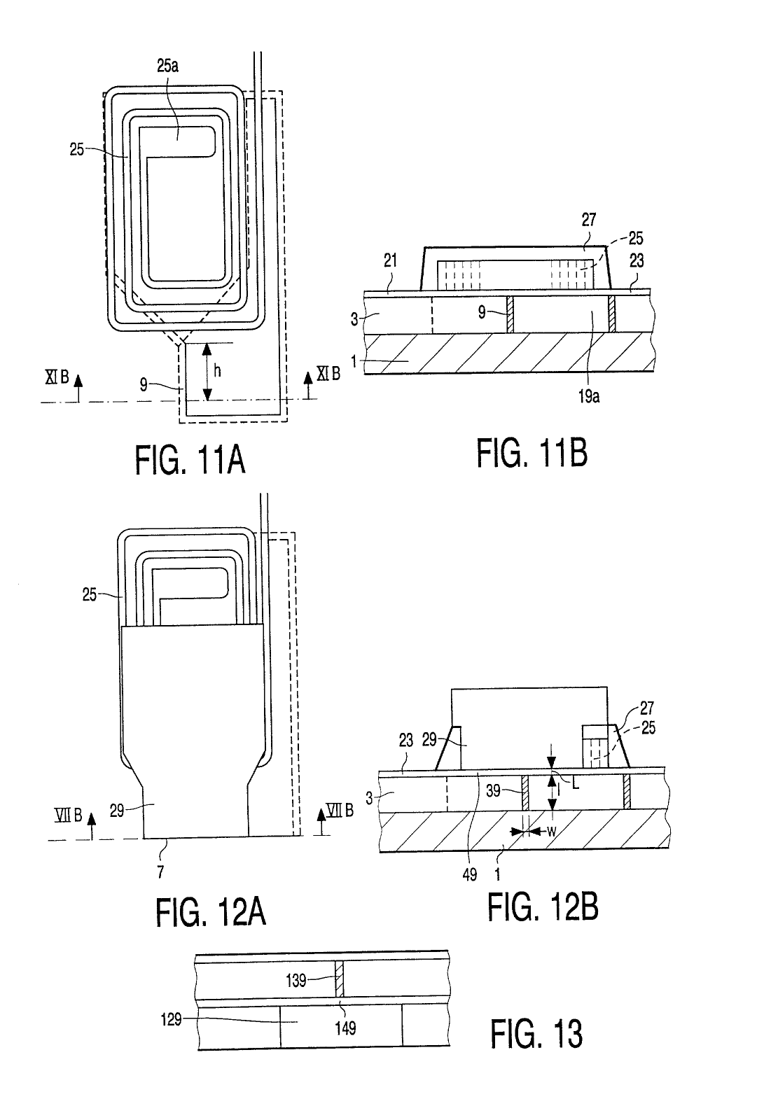

The method further comprises the removal of undesired magnetic material situated near and, in some cases, further away from the magnetic layer 9, including the thickened portion 9a of this layer. The result of this process is shown in the plan view of FIG. 8A and in the sectional view VIIIA-VIIIA of FIG. 8B. For this purpose, use can be made of techniques which are known per se, such as sputter-etching or ion-beam etching. On the resulting structure an insulating material 19, in the present example quartz, is deposited in order to form an insulating layer 19a which covers the structure, as is shown in the plan view of FIG. 9A and the sectional view IXB-IXB of FIG. 9B. In the present example the method further comprises a planarizing operation, for example comprising polishing and/or lapping, which results in a plane surface 21, as is shown in FIG. 10B, which is a sectional view taken at the line XB-XB in the plan view of FIG. 10A. On the thin-film structure thus obtained a layer 23 of, for example, Al₂O₃ or SiO₂ is formed, on which subsequently an inductive transducing element in the form of a coil element 25 is formed by means of thin-film techniques known per se. The coil element 25a has two terminal contacts 25a. An insulating layer 27 is formed by depositing an insulating material over the coil element 25. This is shown in the plan view of FIG. 11A, in which the layer 27 has been omitted for the sake of clarity, and in the sectional view XIB-XIB of FIG. 11B. On the structure thus obtained a magnetic layer is formed by deposition of a magnetic material, such as an NiFe alloy, which layer is subsequently structured so as to form a magnetic pole element 29. After the provision of an optional covering or protective layer the head face 7 is formed by a mechanical operation, such as grinding, polishing and/or lapping. The magnetic layer 9, the pole element 29 and the layer 23 terminate in the head face 7. The magnetic layer 9 forms a magnetic element 39, which adjoins the head face 7 and which in conjunction with the magnetic pole element 29 forms a magnetic yoke for the transducing element. The magnetic element 29 and the magnetic pole element 29 thus function as flux guide elements. The layer 23 then forms a transducing gap 49, which extends between the elements 29 and 39 and which adjoins the head face 7.

The method described hereinbefore results in a magnetic head in an embodiment of the invention as shown in the plan view of FIG. 12A and in the view XIIB-XIIB in FIG. 12B. The magnetic element 39 has a length 1 and a width w and has a height direction h, as indicated in the plan view of FIG. 11A. The magnetic head in accordance with the invention, as is shown in FIG. 12B, has a gap length L, viewed in a direction of movement of a medium to be inscribed and/or read with respect to the magnetic head, which direction corresponds to the height direction mentioned elsewhere in the present document. If desired, the magnetic head may further be provided with a magneto-resistive transducing element.

FIG. 13 shows a magnetic head in an embodiment of the invention during whose manufacture basically the same method steps are used as in the embodiment already described but in where a magnetic pole element 129 is formed before a magnetic element 139 is formed. Again, a transducing gap 149 extends between the magnetic element 139 and the pole element 129.

It is to be noted that the invention is not limited to the embodiments shown. Thus, the invention inter alia also relates to the manufacture of a separate magnetic element, i.e. an element which, unlike those in the embodiments shown, does not form part of a magnetic head. Furthermore, the magnetic element need not have a thickened portion.

1. A method of manufacturing a magnetic element having a length and a width and a height direction, characterized by the following steps:
forming, by removal of material, a recess in a non-magnetic layer having a thickness at least equal to the length of the magnetic element to be manufactured, which recess has an upright wall portion which extends in the height direction of the magnetic element to be manufactured;
depositing a magnetic material, so as to form a magnetic layer on the upright wall portion, which magnetic layer has a thickness related to the width of the magnetic element to be manufactured;
removing deposited magnetic material which is present at least near said magnetic layer on the upright wall portion and which is situated outside said layer;
covering the magnetic layer by depositing an insulating material.

2. A method as claimed in claim 1, characterized in that primarily anisotropic etching is employed to form the recess in the non-magnetic layer.

3. A method as claimed in claim 1, characterized in that the non-magnetic layer is obtained by deposition of a photo-sensitive material, which layer is exposed and developed, after which, in order to form the recess, material is removed at the location of the recess to be formed.

4. A method as claimed in claim 1, characterized in that the non-magnetic layer is obtained by deposition of a material which is sensitive to an electron beam, which layer is subjected to an electron bombardment, after which, in order to form the recess, material is removed at the location of the recess to be formed.

5. A method as claimed in claim 1, characterized in that the magnetic layer is formed by sputter-deposition and/or electroplating.

6. A method as claimed in claim 1, characterized in that primarily anisotropic etching is employed for the removal of deposited material.

7. A method of manufacturing a magnetic head having a head face and including a transducing element and a magnetic element coupled magnetically to the latter and terminating at the head face, the magnetic element being manufactured in accordance with the method as claimed in any one of the preceding claims.

8. A method as claimed in claim 7, in which after the formation of the magnetic layer but before the removal of magnetic material additional material is deposited in an area which extends at a distance from the head face of the magnetic head to be manufactured, in order to make the magnetic layer thicker in said area.

9. A method as claimed in claim 7, in which planarization is effected after covering of the magnetic layer by deposition of a non-magnetic layer.

10. A method as claimed in claim 7, in which after the manufacture of the magnetic element a coil element is provided in order to form the transducing element, as well as a magnetic pole element which terminates at the head face, a layer forming a transducing gap being interposed between the magnetic element and the magnetic pole element.

11. A method as claimed in claim 7, in which prior to the manufacture of the magnetic element a magnetic pole element which terminates at the head face is formed, as well as a coil element in order to form the transducing element, a layer forming a transducing gap being interposed between the magnetic pole element and the magnetic element.

12. A magnetic head manufactured by the method as claimed in any one of the claims 7 through 11.
